(19) United States
(12) Patent Application Publication
(10) Pub. No.: US 2003/0222869 A1
(43) Pub. Date: Dec. 4, 2003

(54) High resolution and clear 3 dimensional image generators

(76) Inventor: Kazutora Yoshino, Madison, WI (US)

Correspondence Address: Yoshino, Kazutora, 226 N. Hillside Tr., Madison, WI, 53705, US

(21) Appl. No.: 10/295,745

(22) Filed: Nov. 15, 2002

Related U.S. Application Data
(63) Continuation of application No. 10/161,180, filed on Jun. 3, 2002.
(63) Continuation of application No. 10/235,575, filed on Sep. 5, 2002.
(63) Continuation of application No. 10/252,882, filed on Sep. 23, 2002.

(51) Int. Cl. G06T 15/00

(52) U.S. Cl. 345/419

(57) ABSTRACT

By this invention, multi-users can view the very clear 3 dimensional objects or images in real time (run time) with high resolutions without special glasses in the space or in the air due to the fast frequency image refreshing rate 2 dimensional image display and its proper usage of the high speed and accurate focus adjustable lens.

This is a continuation of the patent application of “Intelligent System and 3D virtual object generator” U.S. Ser. No.10/161,180, “3 dimensional image projector and holodeck” U.S. Ser. No. 10/235,575 and “High resolution 3 dimensional image generator” U.S. Ser. No. 10/252,882. This invention relates to the image display devices, specifically to 3DTV, hologram, stereo display device that are used for displaying the 3 dimensional object or images and 3D scanners.

### FEDERALLY SPONSORED RESEARCH

Not Applicable

### SEQUENCE LISTING OR PROGRAM

Not Applicable

### BACKGROUND OF INVENTION

### DESCRIPTION OF PRIOR ART

In U.S. Pat. No. 3,647,284, (1970) Virgil B Ethlgs, et al. show the method of showing 3 dimensional images made by the light that was originally scattered by an object. This device put two dish means facing each other. The top dish means has a hole in the middle and 3 dimensional image shows up over this hole when user put the object at the bottom of the bottom dish means. But this device can lift only 3D image of real object by itself and therefore this device by itself would be unsuitable to show the real time (run time) 3 dimensional image. Also, this device can lift only 3D image of real object only in the same size of real object.

U.S. Pat. Nos. 5,954,414, 1999, and 6302,542, 2001, by Tsao indicate the method of making 3D image using a reciprocating motion of screen using deformable lens. But this does not mention practical way of making the “rapid” movement of screen. Also, the system of varifocal optical means is rather complicated and somewhat expensive. Another problems of all is that their varifocal optical means that is the deformable lens/curved mirror does not give satisfactory result for the practical purpose of 3D imaging. Especially when one needs more clear and precise 2D image projection on a screen? This is because deformable lens/curved mirror is very slow in response and accuracy is also very rough. Plus, deforming the lens/curved mirror creates a lot of stress and thereby it would be damaged or broken easily after thousands of times of imaging process. For example, when 50 images are presented in a second, deformable lens/curved mirror changes its form 50 times/sec. So it is 3000 times/min. and 180000 times/hr. According to what people tested so far, it is virtually impractical so far. Another problem of this method is that when the 3D image needs to be big, the system (screen, etc.) must be big as well. For example, if user need 14″ cubic 3D image, the screen must be 14″×14″ at least. This system including mechanical portion, if possible, is very difficult and expensive to make since the system must make reciprocating motion of 14″×14″ screen by 14″ of distance. In many cases, a screen tends to be bent by its inertia, air, etc. and the 3D image gets to be distorted. As a result, this is not a practical method for big 3D imaging system. Another problem of this device is that users cannot touch the 3D images. In many fields such as medical field and engineering field, users desire to have direct touch and interaction with 3D images.

In U.S. Pat. No. 5,956,172 (1999) and U.S. Pat. No. 5,684,621 (1997) by Elizabeth Anne Downing, it shows the way to display the 3D image in a crystal. But user still cannot touch to the 3D image. Also, coupling (intersecting) two light beams is difficult and expensive in many cases since it need to use more direction specifying device such as galvanometers. Also, it is difficult and expensive to create big crystal used in these methods. Also, these methods do not show how to make full color 3D image. It may show only red, green and green color. One of problems of this system is that it is too expensive.

Objects and Advantages

This invention has advantages relative to prior art in

1) It gives clearer and brighter 3D images in the space even at the deep portions of image,

2) It gives high resolution 3D images,

3) 3D images become very well controlled in depth resolution with fast response.

4) The cost efficient,

5) Energy efficient,

6) It looks like the 3D images are in the air.

7) It magnifies 3D image with high angle of views and clear images

### SUMMARY

In spite of the difficulties of prior art, by Virgil B Ethlgs, that could lift 3D image only in real size, we have developed the 3D image lifting magnifier (FIG. 9). Our 3D image lifting magnifier can lift 3D image meanwhile it magnify the original image. One of these examples has following features. It is made of the different shaped inside reflective surfaces. One looks like a dish with a hole. Another look like a mirror with some curvature added. When one put them together with proper distance with object or 3D core image, it would bring magnified object/3D core image up in the air.

In spite of the difficulties of the prior art by Tsao, we developed innovative system for 3D image display.

The recently developed image lifting and magnifying means together with the linear motion of 2D image generating means enables user to touch and interact with 3D images meanwhile the image lifting magnifying means can enlarge 3D core images in real time.

One of our ideas is to create the 3D core images in small volume, for example 2″×2″×2″, and magnify and lift the 3D images to 12″×12″×12″. Since the 3D core image can be small, 2D imaging projection can be made in telecentric/parallel image light optical system. This means that lays of light for the 2D image are parallel to each other so that 2D images on the moving plate in the different depth has the same scaling/size. The smaller size core image generator allows the reduction of the cost versus varifocal optical means and the general cost of the 3D core image generating mean. Also it can create more controlled 3D images relative to the focus adjustable lens means.

But in the case that we need to make big 3D core images, we can also use the focus adjustable lens means such as piezo-electrical lens, electro-optical lens, acousto-optic lens does not physically move, they are practical for the usage of thousand times of image focusing process. Also, physically safe focus adjustable lens/mirrors may work as well. The example of these is speaker-like motion lens, lens with linear motion such as lens with linear motor, lens with linear actuator, lens with magnet & coil together with camera-like focus adjustable lens.

That is, in order to overcome the difficulties of the prior art of varifocal optical mean such as deformable lens/curved mirror, we made the system with the usage of

1) Telecentric/parallel image light optical system and/or

2) Focus adjustable lens means such as piezo-electrical lens, electro-optic lens, acousto lens, and speaker like motion lens/curved mirror speaker-like motion lens, lens with linear motion such as lens with linear motor, lens with linear actuator, lens with magnet & coil, camera-like focus adjustable lens.

Also we apply the linear movement in more practical ways. One example is moving panel on a belt so that it can go really fast since it does not have to go back and force. Another one is to use closed-loop servomotor or linear motors/actuators so that it can give very high precise motion. Linear motor can give the accuracy of 10 micro meter/step (Balder Motor) for example.

The recent development of high definition scanner led the development of FLC (ferromagnetic liquid crystal) and SLM (Spatial Light Modulator: sample by Boulder Nonlinear System), and DLP (Digital Light Processing: sample by Texas Instrument) technology that can project 2D image onto moving medium/plate/screen/scintillator/flourecent plate or moving organic EL display so fast that when the 2D images on 2D image generating means moves, it creates the 3D images. One key is how to create the projecting system with a high speed and a high resolution with a right field of depth together with mechanical practicality of linear motion or rotational motion. We can use servomotor, linear motor, actuator, etc. for linear/rotational motion to create the first enough motion of medium/screen. When 2D images are projected to medium/screen, we may use adjustable focus lens to synchronize the motion of the medium/screen to make clear image or we may use the parallel light images onto the linear motion of the medium/screen so that all 2D images on moving medium/screen are clear no matter where it is. We can use a white screen with mono-color/color projectors with visible light source. We can also use infrared light source and chemical doped crystals for the medium so that it shines when the infrared light source is projected. We can also use the Ultra Violet light source and scintillator for the medium so that projected 2D images on scintillator moves linearly/rotationally create 3D images. Scintillator is the medium/device such as plastic, glass, and gas with doped-chemical, such as florescent inorganic/organic materials, that shift the wavelength of light. Scintillator usually shifts the UV light to the colors such as blue and green color. If gas is used, it can be used to move the containing medium or the image light source in the gas can be moved to create the 3D images. Also, it is possible to put multi-layers of scintillators to make color displays. When the organic EL display (OEL display), Plasma display or 2D display with 2D images is moving linearly/rotationally, it would create 3D images as well. Or lens or reflectors are moving using the 2D images of such display can create the 3D images. Another key is how to transfer the data of 3D images efficiently. One can use the multi-threads with parallel processing CPUs for fast transferring data and/or simplification of the original data for 3D moving images. Also, it can save the 3D data information into RAM at first and keep sending the same data (repeating the same data) to create 3D still body images.

In order to generate the high resolution 3D images, our invention makes a screen move very fast (about 5 time/sec to 70 time/sec) having a projection from High definition SLM/DLP projector such as SLM of 512×512 resolution with 2 kHz 2D image refreshing rate or SLM of 256×256 resolution with 4 kHz 2D image refreshing rate from Boulder Nonlinear Systems or DLP form Texas Instrument. This can create 512×512×250 resolution of 3D images with about 8 times refreshing 3D images per second. This is because 512×512 resolution with 2 kHz=2000 Hz=250×8 Hz. This means that when a linearly moving medium/screen can have 8 times per second 3D images with z-axis of 250 resolutions. If this linear motion is simple reciprocal motion, 4 times going back and forth would give 8 times 3D image refreshing rates. Essentially the faster 2D refreshing rate would give clear 3D images with faster refreshing rates and better resolutions. Examples of the rough response time to signals are shown:

| | |
|---|---|
| SLM (FLC: ferromagnetic liquid | about 25 micro second (analog) |
| crystal) | |
| DLP | about 15 micro second (binary) |
| Organic EL display | about 10 micro second |

Note: Roughly speaking, 1/(response time)=2D image refresh max rate

Another idea is that by creating linear motion/reciprocating motion/rotation of 2D display such as organic EL display, plasma display itself can create the 3D images. This will give high resolution, virtually no flickering, bright and sharp 3D images.

My another idea is to put focus adjustable lens means such as piezo-electric lens, electro-optic lens, acousto-optic lens, deformable lens/mirror, and speaker like motion lens next/in front of 2D display and synchronize the focus with 2D images so that entire image looks like 3D images. This is because virtual depth of 2D image is controlled by the focal length of focus adjustable lens means, by changing the focus, 2D images virtually move in depth. By changing 2D image and the focal length of focus adjustable lens means so fast that viewers percive different depth of 2D images as 3D virtual image.

Another idea is to make fluorescent chemicals radiate in proper wavelength given input wave length particles such as photons. This can make full color 3D display. For example prepare 3 base color (Red, Green, Blue) radiating florescent components in liquid form, gas form, solid form, or mixed form with other components. If with proper wavelengths of input lights (UV light) are concentrated on the desired spot in the material, it radiate at the spot. Giving proper distribution of spots or scanning a spot creates 3D images. Or if this material is like a plate, linear movement of this plate with 2D image creates 3D images. Another way is, to create proper sequence of 2D image(s) inside of florescent material and give the linear movement to the 2D image(s) to create 3D images.

### DRAWINGS

Drawing Figures

FIGS. 1(a),(b),(c) and (a-1) shows the example diagrams of a 3 dimensional image generator with a linear motion generator, a projector, and image lifter/magnifier.

FIG. 2 shows the example diagrams of a core image generator with linear motion.

FIG. 3(a) shows the example diagrams of 2D image projecting system using SLM, DLP, and GLV together with focus adjustable lens means such as piezo-electric lens, electro-optic lens, speaker-like motion lens, and acousto-optic lens.

FIG. 3(b) shows the example diagrams of 2D image projecting system using SLM, DLP, and GLV together with focus adjustable lens means such as piezo-electric lens, electro-optic lens, speaker-like motion lens, and acousto-optic lens for the purpose of telecentric/parallel light.

FIG. 4(a) shows the example diagrams of 2D image projecting system using SLM, DLP, and GLV together with focus adjustable lens means such as piezo-electric lens, electro-optic lens, speaker-like motion lens, and acousto-optic lens having polarized light.

FIG. 4(b) shows the example diagrams of 2D image projecting system using SLM, DLP, and GLV together with focus adjustable lens means such as piezo-electric lens, electro-optic lens, speaker-like motion lens, and acousto-optic lens having polarized light for the purpose of telecentric/parallel light.

FIG. 5(a) shows the example diagram of focus adjustable lens means such as speaker-like motion driven lens.

FIG. 5(b) shows the example diagrams of focus adjustable lens means such piezo-electric lens, electro-optic lens, and acousto-optic lens.

FIG. 6 shows the example diagram of color display optics.

FIGS. 7(a) & (b) show the alternative example diagrams of core image generator with linear motion with a projector. Note this is not a reciprocating movement.

FIG. 8(a) shows the example diagram of core image generator with organic EL display with linear and/or rotational motion.

FIG. 8(b) shows the example diagram of 3 dimensional images in the core image generator using the method of FIG. 8(a).

FIG. 8(c) shows the example diagram of GLVM (grating light valve matrix). This allows creating 2D image in very fast speed (about 20 ns for refreshing a image).

FIG. 9(a) the example diagram of cross-section of an image lifter/magnifier. This one magnifies the original 3D image 4 times bigger and lifts the magnified 3D image up in the air.

FIG. 9-b shows the example diagram of an image lifter and magnifier. This one is made of 2 different curvatures reflective surface with a hole.

FIGS. 9(c-1), (c-2) shows the example diagram of an image lifter and/or magnifier. This one is made of the half (gradient) reflective surface and half (gradient) penetrating surface.

FIG. 10 shows the example calculation of 3D image resolution and 2D image frequency.

FIG. 11 shows the alternative example diagrams of 3 dimensional image generator. These ones involve fluorescent chemicals that radiate proper wavelength of light according to the input light beam with right wavelength.

FIG. 12 shows the alternative example diagram of 3 dimensional image generator.

These are the application of FIG. 11.

### REFERENCE NUMERALS IN DRAWINGS

{1} 3D image generator

{2} 2D image generating panel/screen/display means such as plastic panel, paper with frame, glass, scintillator, plate with florescent chemical component, organic EL display, plasma display, FLC display, LCD, etc.

{3} Moving 2D image generating panel/screen/display means such as plastic panel, paper with frame, glass, scintillator, plate with florescent chemical component, organic EL display, plasma display, FLC display, LCD, etc.

{4} 2D Image projector means

{5} Focus Adjustable Lens means such as piezo-electric lens, electro-optic lens, acousto-optic lens, speaker-like driven lens, and mechanical optical lens.

{7} 3D core image

{8} Image lifting and magnifying means

{9} Lens means

{10} 3D image

{12} 3D core image generator means

{14} support body

{17} 2D image motion generator means such as open/closed-loop linear motor, servomotor, solenoid, actuator.

{20} Moving Ribbon means

{21} Fixed Ribbon means

{22} Air Gap

{40} Laser means

{42} Light source means

{50} Input device means

{70} 2D core image generator means such as FLC, SLM, DLP, GLV

{72} Retarder

{74} Polariza beam splitter cube

{76} Magnet means

{78} Coil means

{80} Controller means

{82} Motor driver

{86} Laser driver

{87} Master driver

{88} Image data driver

{90} Computer means

{91} video card means

{92} CPU means

{93} Other components

{94} 3D image data

{100} Table application with 3D image generator

{101} Chemical components such as florescent chemicals.

{102} Container means

### DETAILED DESCRIPTION

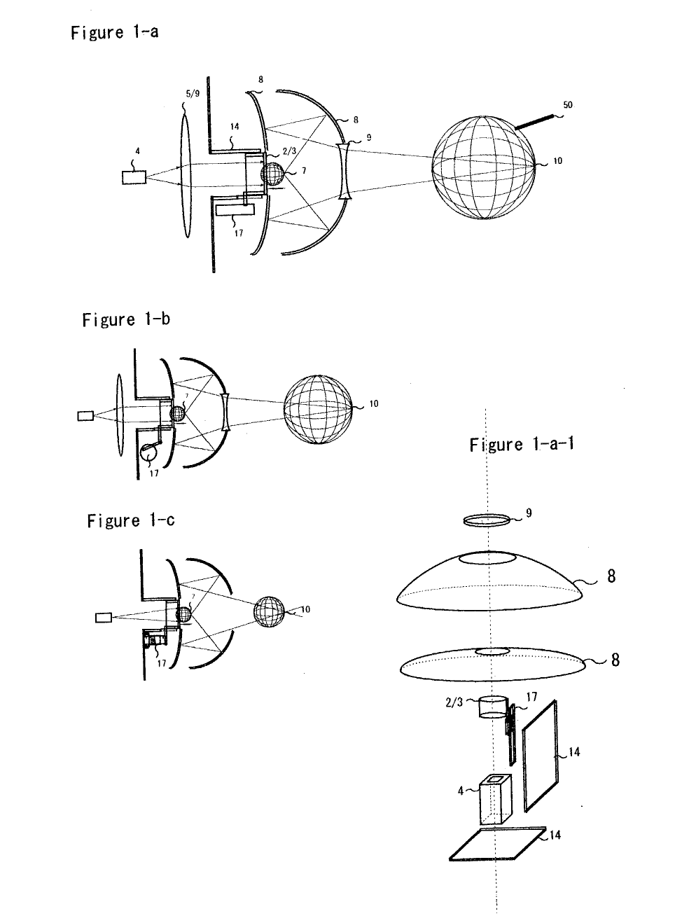

Description—FIG. 1-a, b, c and 1-a-1: Preferred Embodiment

A preferred embodiment of the 3D image generator is illustrated in FIGS. 1 -a, b, c.

FIGS. 1-a, b, c shows the example diagram of a 3 dimensional image generator with linear motion. {1} 3D image generator is composed of 2D image generating screen means {2}, moving 2D image generating screen means {3}, 2 dimensional (2D) image projector means {4}, and focus adjustable lens means {5}. 2D images corresponding to transverse location are generated on a screen {2} moving linearly such as reciprocal motion in the position corresponding to the proper depth so that the resultant images become 3D images. The 2D image projector {2} can include 2D core image generator means such as FLC, SLM, DLP, and GLV {70}.

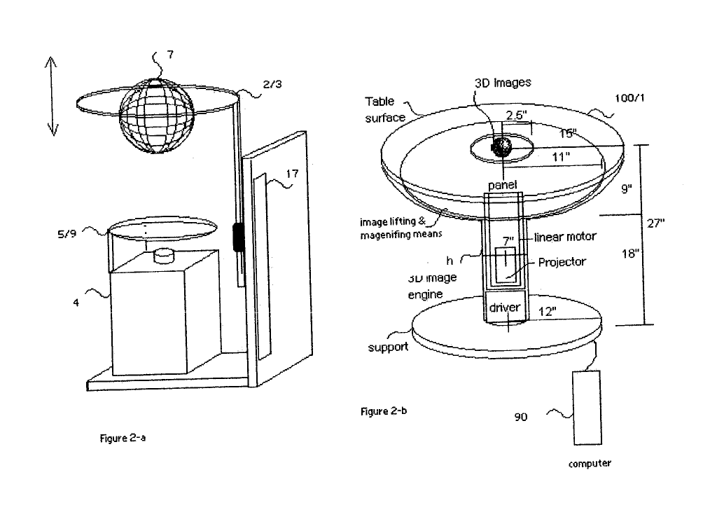

FIGS. 2, 3, 4, 5, 6, 8, 9, 10 —Additional Embodiments

FIG. 2-a shows the example diagram of a 3 dimensional core image generator with more detailed components of moving 2D image generating screen means {2}/{3}, 2D image projector means {4}, 2D image motion generator means {17} and Focus adjustable lens means {5}, {9}. The moving screen means has a linear motor and, its sensor as closed-loop control in this example. The 2D image projector {2} can include 2D core image generator means such as FLC, SLM, DLP, and GLV {70}.

FIG. 2-b shows the example diagram of a 3 dimensional core image generator {1} with Table-like application {100}. This one is the 3D image generator in table form {100} . Computer {90} can be embedded in the table or outside. Optionally input devices can be added to operate the 3D images.

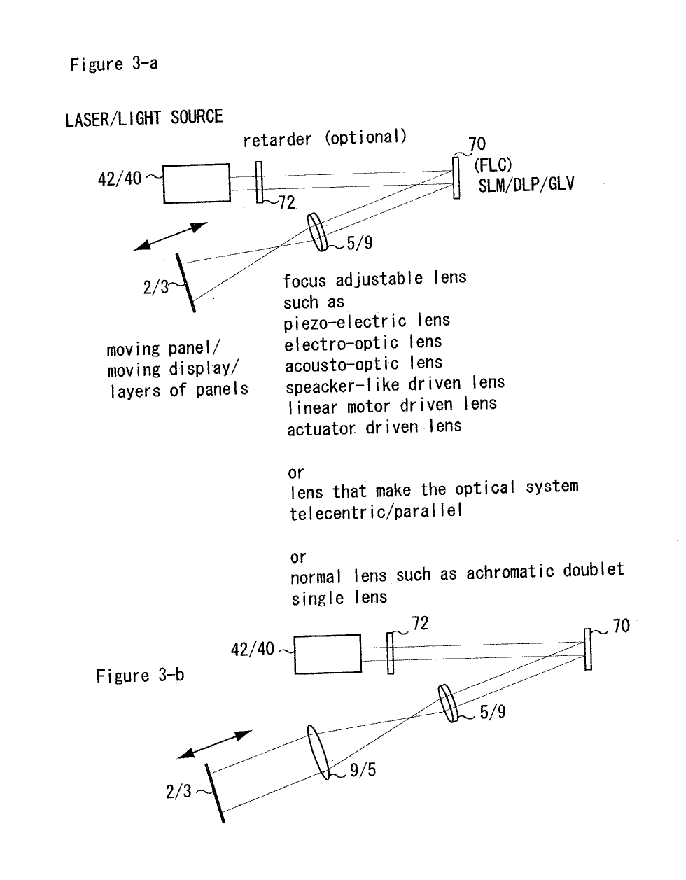

FIG. 3-a shows the example diagram of a right-left method of 2D image projecting system with moving panel/screen {3}. This is composed of the laser {40} or light source {42}, a retarder {72}, 2 dimensional core image generator means such as FLC, SLM, DLP, GLV {70}, and focus adjustable lens means such as piezo-electric lens, electro-optic lens, acousto-optic lens, speaker-like driven lens and mechanical optical lens.

FIG. 3-b shows the example diagram of a right-left method of 2D image projecting system with moving panel/screen {3} with the telecentric/parallel light beam method. The 2D images have the same size with all depth of the screen movement because the light beam for the image is parallel to each other. This can be composed of the laser {40} or light source {42}, a retarder {72}, 2 dimensional core image generator means such as FLC, SLM, DLP, GLV {70}, and lens means {9} and/or focus adjustable lens means such as piezo-electric lens, electro-optic lens, acousto-optic lens, speaker-like driven lens, and mechanical optical lens.

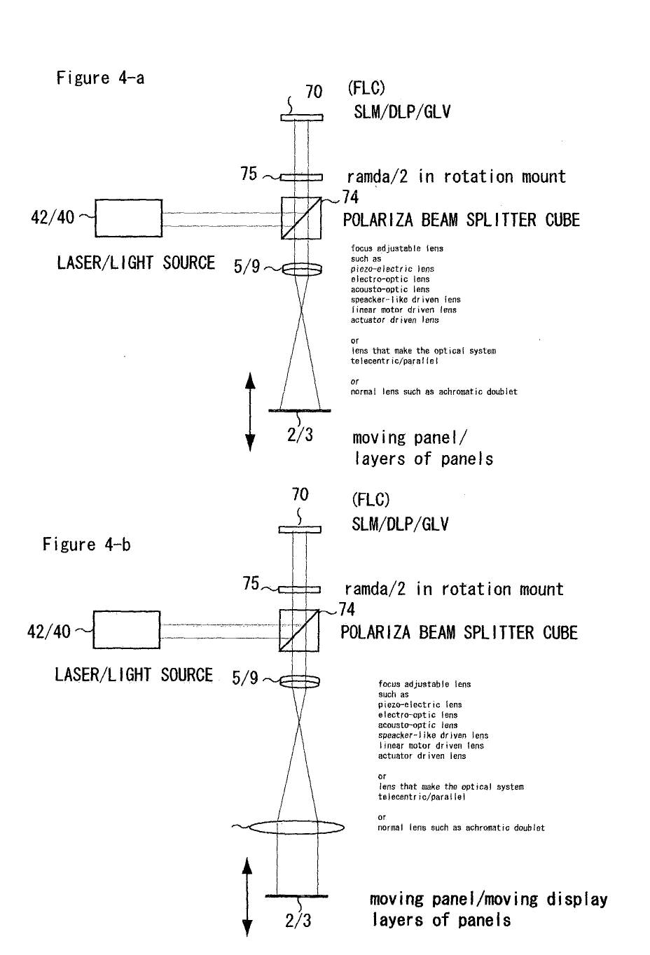

FIG. 4-a shows the example diagram of a polarized light method of 2D image projecting system with moving panel/screen {3}. This is composed of the laser {40} or light source {42}, a retarder {72}, 2 dimensional core image generator means such as FLC, SLM, DLP, GLV {70}, polariza beam splitter cube {74}, polarizing material {75}, and focus adjustable lens means such as piezo-electric lens, electro-optic lens, acousto-optic lens, speaker-like driven lens, and mechanical optical lens.

FIG. 4-b shows the example diagram of a polarized light method of 2D image projecting system with moving panel/screen {3} with the telecentric/parallel light beam method. The 2D images have the same size with all depth of the screen movement because the light beam for the image is parallel to each other. This can be composed of the laser {40} or light source {42}, a retarder {72}, 2 dimensional core image generator means such as FLC, SLM, DLP, GLV {70}, polariza beam splitter cube {74}, polarizing material {75}, and lens means {9} and/or focus adjustable lens means such as piezo-electric lens, electro-optic lens, acousto-optic lens, speaker-like driven lens, and mechanical optical lens.

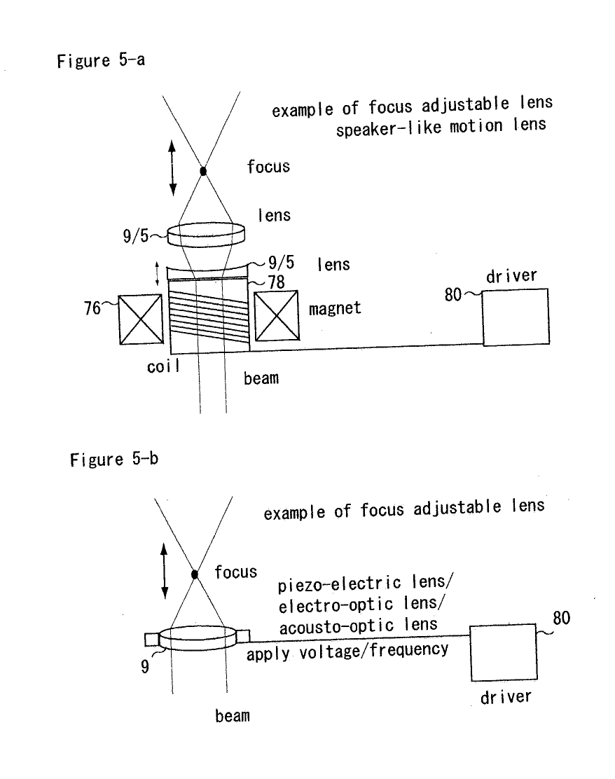

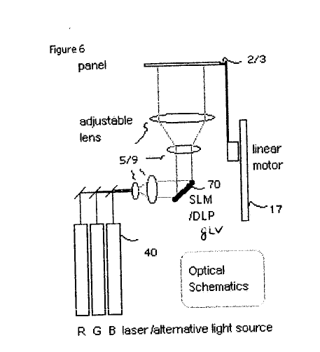

FIG. 5-a shows the example diagram of focus adjustable lens means {5} such as speaker-like motion driven lens. It is composed of lens means {9}, magnet means {76}, coil means {78}, and a driver/controller {80}. The lens means {9} can be moved by mechanical ways such as linear motor, actuator, and/or optical-mechanical movements.

FIG. 5-b shows the example diagrams of focus adjustable lens means {5} such piezo-electric lens, electro-optic lens, and acousto-optic lens.

FIG. 6 shows the example diagram of color display optics. It is composed of the red, green, blue laser means {40} or light source {42} with lens means {9} and/or focus adjustable lens means {5}, 2D core image generator means such as FLC, SLM, DLP, GLV {70}, and moving 2D image generating screen means {3}.

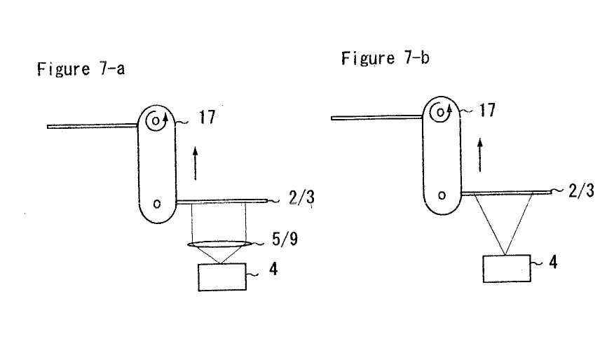

FIGS. 7-a, b show the alternative example diagrams of core image generator {12}. It is composed of 2D image motion generator means {17}, moving 2D image generating screen {3}. 2D image projector {4} and focus adjustable lens {5} are added if necessary. By having a moving belt with panels in one direction, it creates linear motion of the moving screen more efficient in energy and time. Note this is a linear movement but not a reciprocating movement.

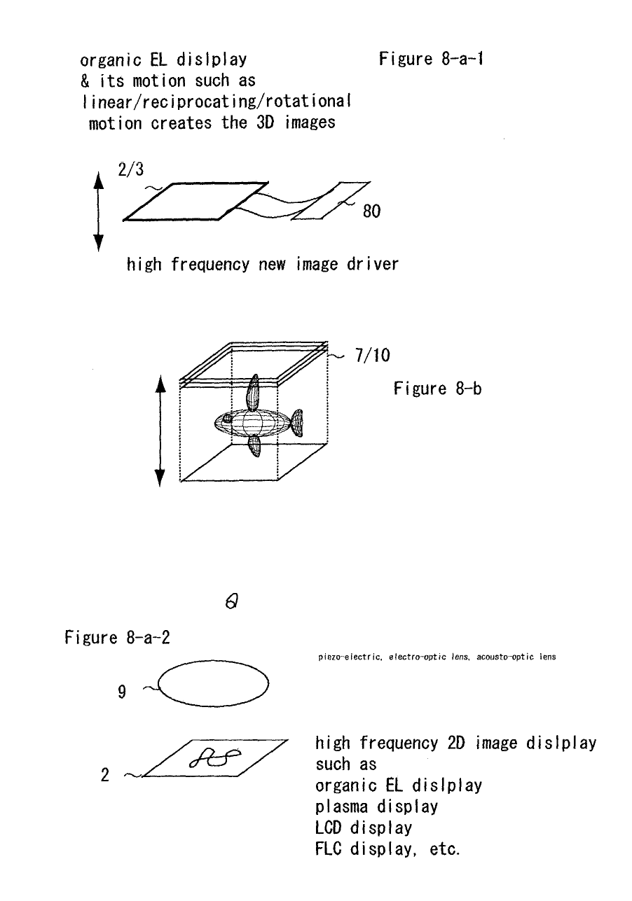

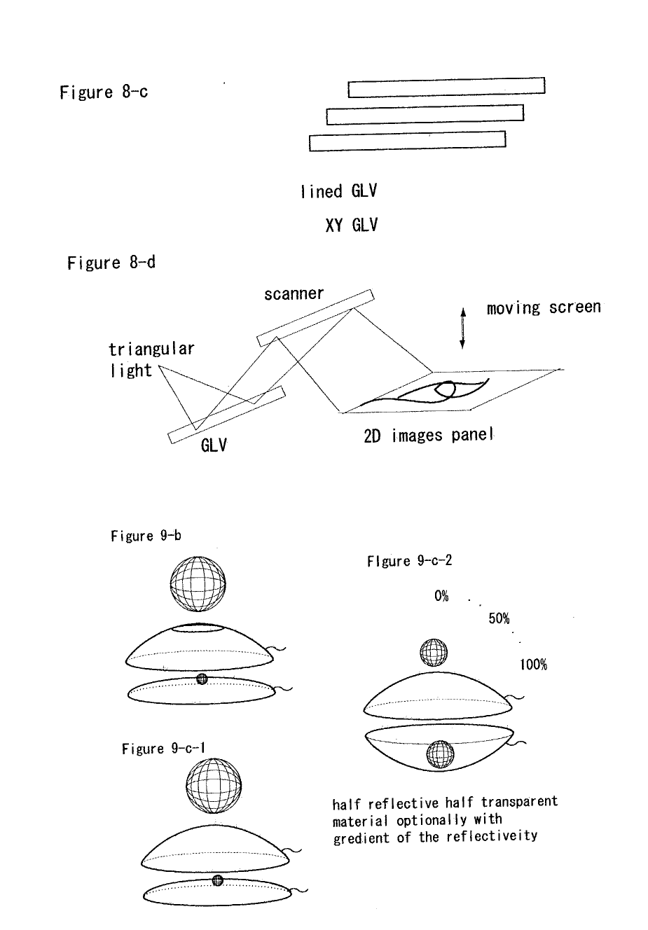

FIG. 8-a-1 shows the example diagram of 3D image generator {1} with organic EL display with linear and/or rotational motion. It is composed of the moving 2D image generating display {3} such as organic EL display, plasma display, liquid crystal display, its driver/controller {80}, and 2D image motion generator means {17}.

FIG. 8-b shows the example diagram of 3 dimensional images in the core image generator using the method of FIG. 8-a.

FIG. 8-c shows the example diagram of GLVM (grating light valve matrix). This allows creating 2D image in very fast speed (about 20 ns for refreshing a image). It is made of many grating light valves next to each other to create matrix so that when light is applied to the GLVM it creates the 2D image directly. This allows a very fast 2D imaging system versus the fact that normal GLV and scanner system is relatively slow because scanners slow down the 2D image refresh rate.

FIG. 8-d shows the example diagram of 3D image generator {1} with GLV 2D projector.

FIG. 8-a-2 shows the alternative example diagram of 3D image generator {1}. It is composed of a high frequency 2D image display such as organic EL display, plasma display, FLC display, and LCD together with focus adjustable lens {5}. By choosing the proper magnification corresponding to a 2D image, it can give a virtual depth for the 2D image. By changing 2D images and the magnification of the focus adjustable lens simultaneously, it can create 3D images.

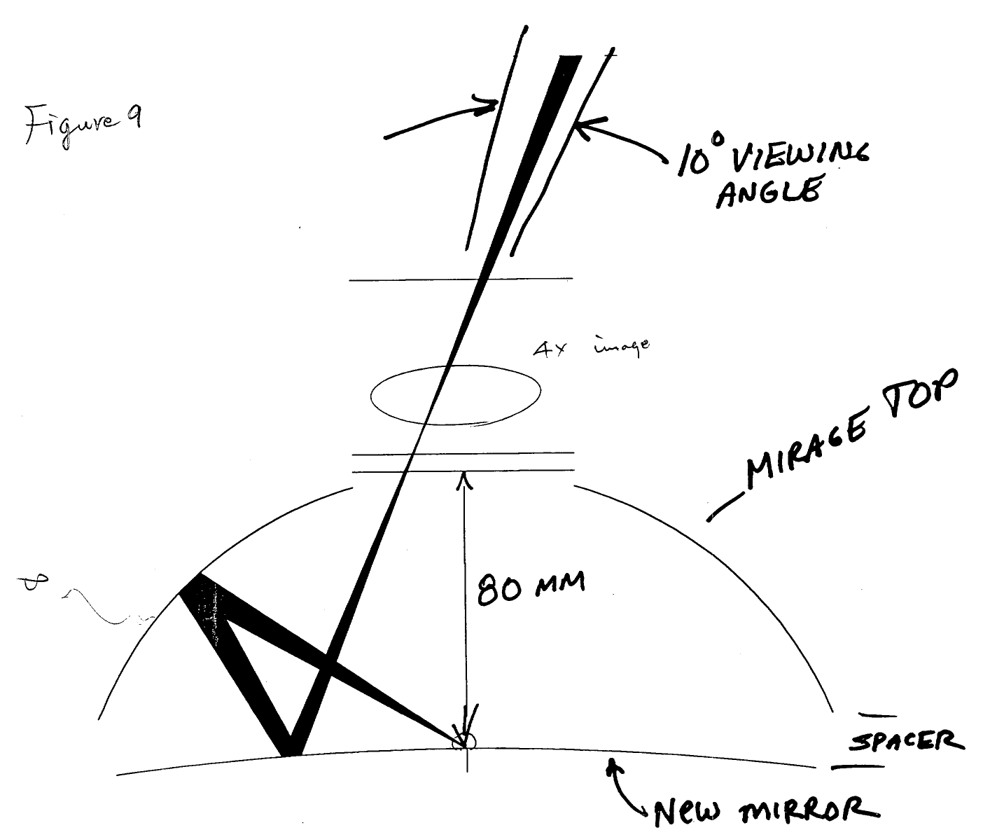

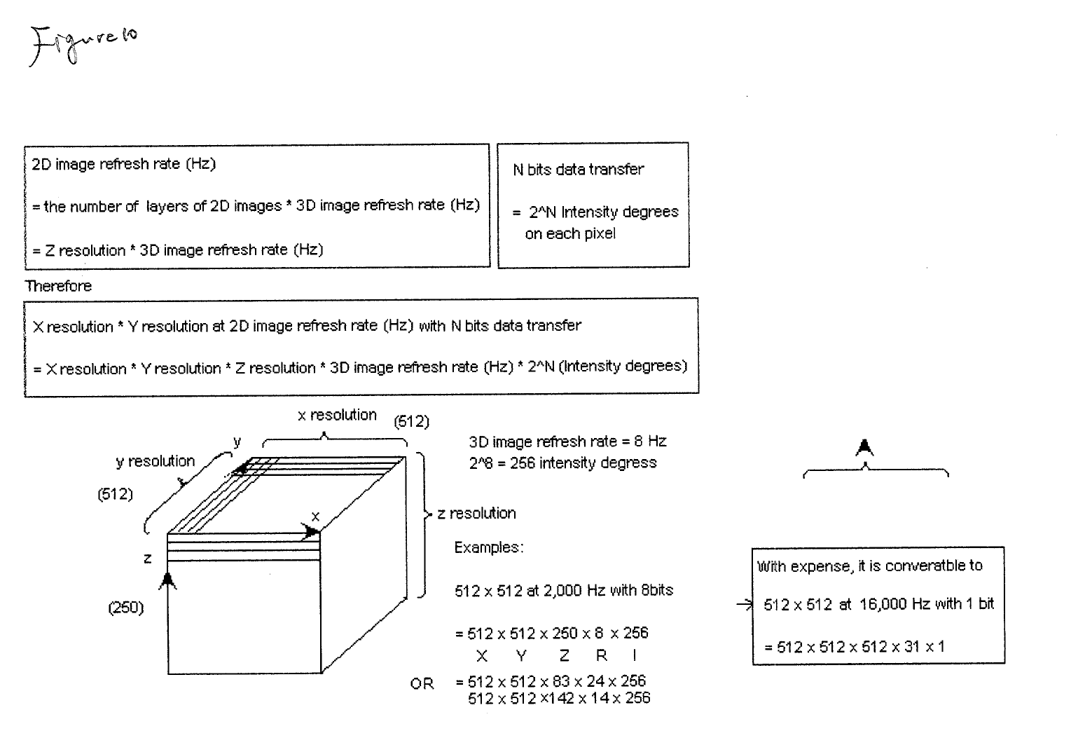

FIG. 9-a the example diagram of cross-section of an image lifter and magnifier means. It is composed of curved surfaces such as parabola shape and portion of sphere with holes. The surface is made of reflective so that it can reflect images in proper way. This example magnifies the original 3D image 4 times bigger and lift the magnified 3D image up in the air. The top portion has higher curvature and bottom portion is slightly curved mirror in this example. By choosing proper curvature, it can magnify 3D images in different magnitude. By having a deformable material to choose the curvatures, this can be used as adjustable magnification image lifter and magnifier means.

FIG. 9-b shows the example diagram of an image lifter and magnifier. This one is made of 2 different curvatures reflective surface with a hole.

FIG. 9-c-1 the example diagram of an image lifter and magnifier means. It is composed of curved surfaces such as parabola shape and portion of sphere with gradient/half-penetrating and half reflective surface. So users can view the magnified image through the half-penetrating material.

FIG. 9-c-2 the example diagram of an image lifter and magnifier means. It is composed of curved surfaces such as parabola shape and portion of sphere with gradient-penetrating and gradient reflective surface. So users can view the magnified image through the gradient-penetrating material.

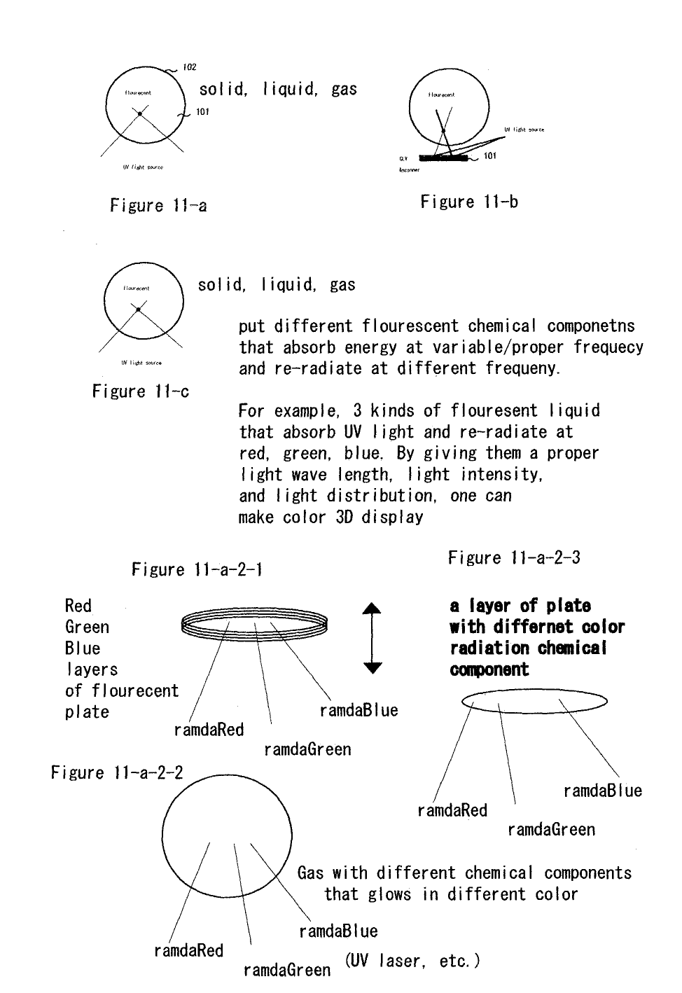

FIG. 10 shows the example calculation of 3D image resolution and 2D image frequency.

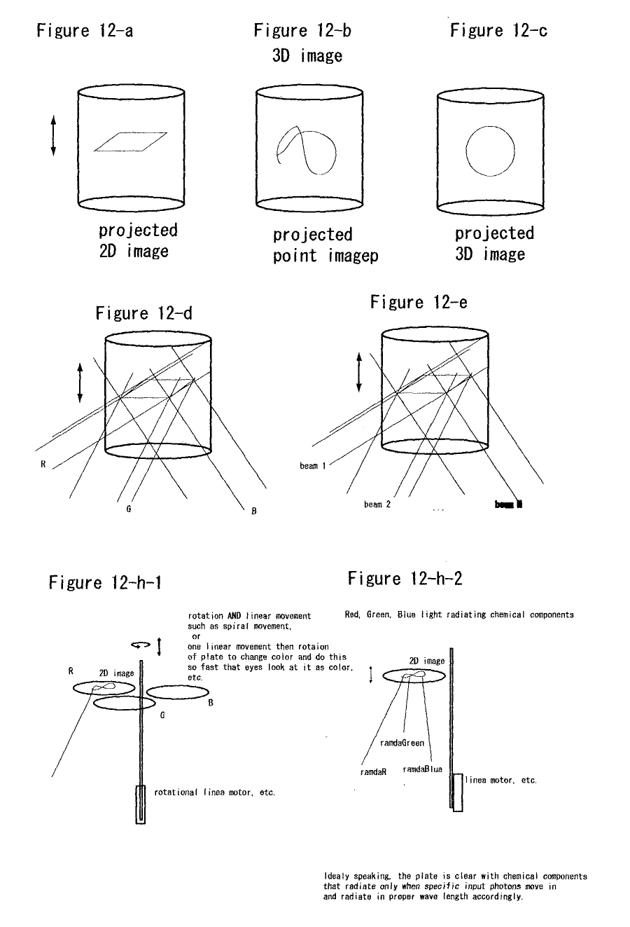

FIGS. 11, 12 —Alternative and Other Embodiment—and Examples

FIG. 11 and FIG. 12 shows the alternative example diagrams of 3 dimensional image generator {1}. These ones involve fluorescent chemicals {101} that radiate proper wavelength of light according to the input light beam with right wavelength. For example, the chemicals in scintillator, florescent liquid, and florescent gas radiate colorfully with UV light projected. By concentrate the light beam path to a point, one spot shines vividly. By giving a distribution of these spots, and/or by moving the spot, it can create 3D images. For example, if 2D image plate is made in this florescent material superposing the 2D images generated by the 2D image generator means {70}, and the 2D image plate is moved rapidly, it creates 3D images. By choosing proper color radiation chemical material, 3D image can be made in color as well.

Advantages

As mentioned, this invention has advantages relative to prior art in

1) It gives clearer and brighter 3D images in the space even at the deep portions of image,

2) It gives high resolution 3D images,

3) 3D images become very well controlled in depth resolution with fast response.

4) The cost efficient,

5) Energy efficient,

6) It looks like the 3D images are in the air.

b 7) It magnifies 3D image with high angle of views and clear images

Operation—FIG. 1, FIG. 2, FIG. 7, FIG. 8

The image lifter and magnifier means and the input device enables user to interact with the 3D image directly. This has a good effect in many fields. Especially when a haptics system is added to get the feeling of touch of 3D image, it shows many applications in medical fields.

One example of the usage of the 3D image generator is in engineering field. Engineers can view the parts or how a designed system works in 3D and interact with them before constructing real objects. This helps a lot of researches in time and costs.

Another example of usage is that bioinformatists can design their proteins, drugs interfacing directly with 3D proteins/drug image by their hand, input device, etc.

One example is in the medical field, students/doctor can practice virtual operation many times using this device/system having a feeling touch of 3D image of patient's organs, teeth, and brains, infant in a mother of humans, lungs. The 3D data acquired from ultrasound scanner, CT scanner, X-rays, MRI, diffusion MRI can be sent to the 3D image generator. Doctors can look at the progress of the infants' growth in mothers' body in 3D form including their organs, which can help doctors to judge/diagnose/give a lot of treatments to the infants who is born yet. In recent years, most of brain image by MRI is pictured in sequence of the 2D pictures. Often, the pictures are flipped and doctors make incorrect decisions. These types of problems are a big problem in medical field and need to be fixed. Since the 3D image generator can give the 3D image directly, it can reduce the problem such that. Also the family/patient can understand what is happening more clearly when doctors need to explain it. It helps the efficiency of the medical care. Also, 3D image generator allow doctors to view the patient brain in 3D so that s/he can visualize and judge the distance of section for operation much simpler and best of all s/he can practice the operation of the patient's brain many times before actually operating the patient's real brain. From the words of doctors we know of this 3D image generator can bring a revolution in medical field.

Conclusion, Ramifications, and Scope

By this invention, multi-users can view the very clear 3 dimensional objects or images in real time (run time) with high transverse resolution and depth resolution without special glasses in the air.

TABLE 1

| | X | Y | Z | Color | I | Refresh | Operator |
|---|---|---|---|---|---|---|---|
| GLV | 1024 | 1024 | 1024 | 256 | | 40 | Super computer/PC with Custom board |
| | 1024 | 1024 | 1024 | | 256 | 24 | PC with Custom board/S.C. |
| | 1024 | 1024 | 512 | | 256 | 48 | PC with Custom board/S.C. |
| | 1024 | 1024 | 1024 | | 1 | 17 | PC with Custom board/S.C. |
| DLP | 1028 | 768 | 198 | 256 | | 12 | PC with custom board |
| * | 768 | 768 | 198 | 256 | | 24 | PC with custom board |
| SLM | 1024 | 1024 | 1024 | | 1 | 17 | PC with Custom board/S.C. |
| | 512 | 512 | 512 | | 1 | 35 | PC with Custom board/S.C. |
| | 512 | 512 | 256 | 256 | | 7 | PC with PCI & DAC boards |
| ** | 512 | 512 | 256 | | 256 | 7 | PC with PCI & DAC boards |
| | 512 | 512 | 142 | | 256 | 14 | PC with PCI & DAC boards |
| | 512 | 512 | 83 | | 256 | 24 | PC with PCI & DAC boards |
| | 256 | 256 | 256 | 256 | | 15 | PC with PCI & DAC boards |
| * | 256 | 256 | 256 | | 256 | 15 | PC with PCI & DAC boards |
| | 256 | 256 | 200 | | 256 | 20 | PC with PCI & DAC boards |
| | 256 | 256 | 142 | | 256 | 28 | PC with PCI & DAC boards |

| | | | | | | |
|---|---|---|---|---|---|---|
| AOD | 200 dots/plane | 200 | 256 | | 40 | PC with DAC boards |
| | 200 dots/plane | 200 | | 256 | 40 | PC with DAC boards |
| | 200 dots/plane | 150 | | 256 | 24 | PC with DAC boards |
| | 200 dots/plane | 120 | | 1 | 24 | PC with DAC boards |
| GALV | 70 dots/plane | 70 | 256 | | 8 | PC with DAC boards |
| | 70 dots/plane | 70 | | 256 | 8 | PC with DAC boards |
| | 70 dots/plane | 70 | | 1 | 8 | PC with DAC boards |
| | 50 dots/plane | 100 | | 1 | 8 | PC with DAC boards |

I claim

1. The three dimensional image generator means that creates three dimensional images comprising the devices selected from the group consisting of
1) two dimensional image generating panel means
2) two dimensional image motion generator means
3) two dimensional image projector means
4) optionally, image lifting and magnifying means
5) optionally, input device means

2. The invention of claim of [1], wherein said two dimensional image generating panel means is composed of the components from the group consisting of
plastic screen, paper screen, glass screen, film, organic material screen, inorganic material screen, crystal, plasma gas, gas with container, liquid with container, solid material, superconductors,
lens,
organic el display, plasma display, ferromagnetic liquid crystal display, liquid crystal display, high frequency two dimensional display.

3. The invention of claim of [1], wherein said two dimensional image motion generator means is composed of the components from the group consisting of
open-loop or closed-loop motion generators such as linear motor, linear actuator, magnet and coil actuator, solenoid, ultrasound motor, servo motor, direct-current motor, alternative current motor, engine,
bearings, air bearings,
Support of said two dimensional image generating panel controllers of said motors.

4. The invention of claim of [1], wherein said two dimensional image projector means is composed of the components from the group consisting of
1) two dimensional image generator means
2) controllers of sail two dimensional image generator means
3) optical instrument means

5. The invention of claim of [4], wherein said two dimensional image generator means is composed of the components from the group consisting of
ferromagnetic liquid crystal display, liquid crystal display, spatial light modulator, digital light processor, grating light valve with scanner, grating light valve matrix, organic el display, plasma display.

6. The invention of claim of [4], wherein said optical instrument means is composed of the components from the group consisting of
lens means comprising lens, concave lens, convex lens, sheet lens, optical lens, magnet lens
reflector means comprising mirrors, curved mirrors, parabola like mirror, and part of sphere like mirrors
focus adjustable lens means

7. The invention of claim of [6], wherein said focus adjustable lens means is composed of the components from the group consisting of
piezo-electric lens, electro-optic lens, acousto-optic lens, speaker-like driven lens, linear motor driven lens, actuator driven lens, magnet and coil driven lens, and mechanical optical lens.

8. The invention of claim of [1], wherein said image lifting and magnifying means is composed of the components from the group consisting of
curved or flat reflective mirrors, curved or flat reflective mirrors with holes, parabola mirrors with holes, a part of sphere shape reflective mirror with hole
lenses, lens means.

9. The invention of claim of [1], wherein said input device means is composed of the components from the group consisting of
ultra-sound position and orientation tracking devices, electro-magnetic wave position and orientation tracking devices, haptics system, infrared position and orientation tracking system, and position-orientation-motion monitoring system.

10. The 3D image generator means comprising the components selected from the group consisting of
chemical component means
image projector means

11. The invention of claim of [10], wherein said chemical component means is composed of the components from the group consisting of
fluorescent atoms/molecules, fluorescent atoms/molecules in solid plastic, fluorescent atoms/molecules in liquid form, fluorescent atoms/molecules in gas form, plasma gas, vapors of chemical components, water vapor.

12. The invention of claim of [10], wherein said image projector means is composed of the components from the group consisting of
optionally, container means
image pattern generating means
light source means
optical device means

13. The invention of claim of [12], wherein said container means is composed of the components from the group consisting of
no container, plastic container, glass container, containers.

14. The invention of claim of [12], wherein said image pattern generating means is composed of the components from the group consisting of
ferromagnetic liquid crystal, liquid crystal, digital light processor, grating light valve, grating light valve matrix.

15. The invention of claim of [10], wherein said light source means is composed of the components from the group consisting of
laser beam source, plasma light bulb, light bulb, fluorescent light, halogen light, ultra-violet light source, ultraviolet laser, infrared light, infrared laser, visible light source, white laser, red laser, green leaser, blue laser.

16. The invention of claim of [10], wherein said optical device means is composed of the components from the group consisting of
lens, retarder, polarizing material, polariza beam splitter cube, said focus adjustable lens means comprising
piezo-electric lens, electro-optic lens, acousto-optic lens, speaker-like driven lens, linear motor driven lens, actuator driven lens, magnet and coil driven lens, and mechanical optical lens.

17. The 3D image generator means comprising the components selected from the group consisting of
image generating panel means
focus adjustable lens means

18. The invention of claim of [17], wherein said image generating panel means is composed of the components from the group consisting of
organic el display, plasma display, ferromagnetic liquid crystal display, liquid crystal display, spatial light modulator, digital light processor, grating light valve with scanner, grating light valve matrix.

19. The invention of claim of [10], wherein said optical device means is composed of the components from the group consisting of
piezo-electric lens, electro-optic lens, acousto-optic lens, speaker-like driven lens, linear motor driven lens, actuator driven lens, magnet and coil driven lens, and mechanical optical lens.

20. The image lifter means comprising the components selected from the group consisting of
Curved shaped with hole inside reflective materials
Curved shaped with half-penetrating and half reflective surface materials means
Curved shaped with reflective gradient surface materials means
